(19) United States
(12) Patent Application Publication
(10) Pub. No.: US 2004/0204199 A1
(43) Pub. Date: Oct. 14, 2004

(54) Hand held communication device with decoupled antenna

(76) Inventors: Glenn Scott Zax, Boynton Beach, FL (US); Lorenzo A. Ponce De Leon, Lake Worth, FL (US); Robert Andrew Kroegel, Boynton Beach, FL (US); Glafkos K. Stratis, Lake Worth, FL (US); Neil Johan Schmertmann, Boynton Beach, FL (US)

Correspondence Address: VEDDER PRICE KAUFMAN & KAMMHOLZ, 222 N. LASALLE STREET, CHICAGO, IL, 60601, US

(21) Appl. No.: 10/334,351

(22) Filed: Dec. 31, 2002

(51) Int. Cl. H04B 1/38

(52) U.S. Cl. 455/575.1; 455/90.3

(57) ABSTRACT

A hand held communication device (10) employs a first flip portion (14) that is pivotal with respect to a base portion (12), wherein the first flip portion (14) includes an antenna (20) and at least a power amplifier circuit (200) operatively coupled to an antenna (20). A second flip portion (16), also pivotal with respect to the base portion (12), includes at least one of a display (24) and a microphone (22). The first flip portion (14) preferably fits within a recessed area (46) of the second flip portion (16) and deploys automatically when the hand held device is opened.

### CROSS REFERENCE TO RELATED CO-PENDING APPLICATION

The present application is related to and hereby incorporates by reference co-pending U.S. patent application Ser. No. ______ , having attorney docket number PT01491V entitled “Wireless Communication Device with Automatically Deploying and Retracting Antenna”, filed on an even date herewith, and assigned to the assignee of the present application.

### FIELD OF THE INVENTION

The invention relates generally to wireless communication devices and, more particularly, to flip style, wireless, hand held devices.

### BACKGROUND OF THE INVENTION

Wireless hand held devices, such as cellular phones, pocket personal computers, and other devices that employ wireless communication circuits, can benefit from improved antenna efficiency to avoid dropped telephone calls or loss of communicated information.

Antenna location on the device can effect antenna performance. For example, it is typically helpful to move radiating elements, such as antennas, away from the user of the wireless hand held device. Wireless hand held devices are known to employ telescoping antennas and fixed antennas that may be employed for example in flip style wireless electronic devices which typically have a hinge mechanism to allow different portions of the housing to collapse upon one another to form a compact hand held device. Forms of the flip style wireless hand held devices include, for example, clam shell and non-clam shell designs, as known in the art.

A flip open antenna design has been proposed for a hand held communication device, wherein the flip open antenna includes a first piece or “flip” that has only an antenna element therein that typically extends the length of the flip element. The flip element is pivotably mounted on a communication housing to move between a closed position adjacent to the housing and an operational position angularly spaced from the housing. A second flip element has a conductive element that acts as a ground plane and is pivotably mounted on the housing. The second flip element moves between a closed position adjacent the housing and an open position angularly spaced from both the housing and the first flip element that contains the antenna. When the first and second flips are in a closed position, the first or antenna flip element receives the second or conductive flip element and covers controls on the housing. However, such multi-flip hand held devices typically embed an antenna in the flip element along the length of the flip element, thereby reducing antenna efficiency. The housing also includes all radio frequency (RF) elements, other than the antenna, thereby concentrating radiating elements closer to a user and reducing antenna efficiency. For example, such designs employ power amplifiers and other RF radiating elements within the housing, which is typically held by a user close to his or her body, thereby reducing antenna efficiency. Also, such multi-flip device designs are not known to use decoupling elements to decouple RF energy from different flip elements, thereby also reducing efficiency.

In addition, flip open antenna designs typically require a manual process to deploy the antenna. For example, a user must pull an antenna flip out from a base flip which in turn deploys an internal flip that contains an earpiece or speaker that is held to a user's ear. An automatic deployment of the antenna flip would be more desirable.

### BRIEF DESCRIPTION OF THE DRAWINGS

The invention will be more readily understood with reference to the following drawings wherein like reference numerals represent like elements and wherein:

FIG. 1 is a perspective view of one example of a hand held communication device in accordance with one embodiment to the invention;

FIG. 2 is a block diagram representation of a hand held communication device employing multiple flip portions in accordance with one embodiment to the invention;

FIG. 3 is a block diagram showing in more detail one example of a hand held communication device in accordance with one embodiment to the invention;

FIG. 4 is an exploded view of the hand held communication device of FIG. 1 showing a hinge mechanism in accordance with one embodiment to the invention;

FIG. 5 is a perspective view of a flip portion that receives an antenna flip portion;

FIG. 6 is another perspective view of a flip portion as shown in FIG. 5;

FIG. 7 is a perspective view of a hand held communication device shown in FIG. 4;

FIG. 8 is another perspective view of the antenna flip portion shown in FIG.7;

FIG. 9 is a cross sectional view of the antenna flip portion shown in FIG. 8; and

FIG. 10 is a cross sectional view of the flip portion shown in FIG. 6.

### DETAILED DESCRIPTION OF A PREFERRED EMBODIMENT

Briefly, a hand held communication device and an antenna employ a first flip portion, such as an antenna flip portion, that is pivotal with a base portion wherein the first flip portion includes the antenna and at least a power amplifier circuit operatively coupled to the antenna. A second flip portion, also pivotal with respect to the base portion, includes at least one of a display and a microphone. The base portion of the hand held communication device includes at least a speaker and a baseband processing circuit that is operative to at least process baseband data, in a digital domain, from a signal received by the antenna located in the first flip portion. In one embodiment, an RF decoupling element, such as an RF choke element, is included in the first flip portion to decouple radio frequency energy communicated by the antenna from baseband digital data provided by the baseband processing circuit.

In another embodiment, the second flip portion further includes a recessed portion or area, such as defined by integral side walls, to receive at least a portion of or all of the first flip portion. In one example, the first flip portion is sized to fit within the recessed area of the second flip portion when the second flip portion and first flip portion are in a closed position. As such, among other advantages, the antenna and hand held communication device combines at least both the antenna and power amplifier circuit in one flip portion to group the primary radiating elements on a common flip portion which, when opened with respect to the base portion, is positioned to be away from a user to enhance antenna and device performance. The second flip portion may include for example a microphone and/or display and the base portion may include a keypad, speaker and display so that the base portion may be held to a user's ear and the user may speak into the microphone of the second flip portion while the first flip portion is positioned to be down and away from a user. In addition, in the embodiment where the second flip portion includes a recessed area for receiving the first flip portion that contains the antenna, a compact hand held wireless communication device is provided when the flip portions are in a closed position thereby protecting the antenna element. Other advantages will be recognized by those of ordinary skill in the art.

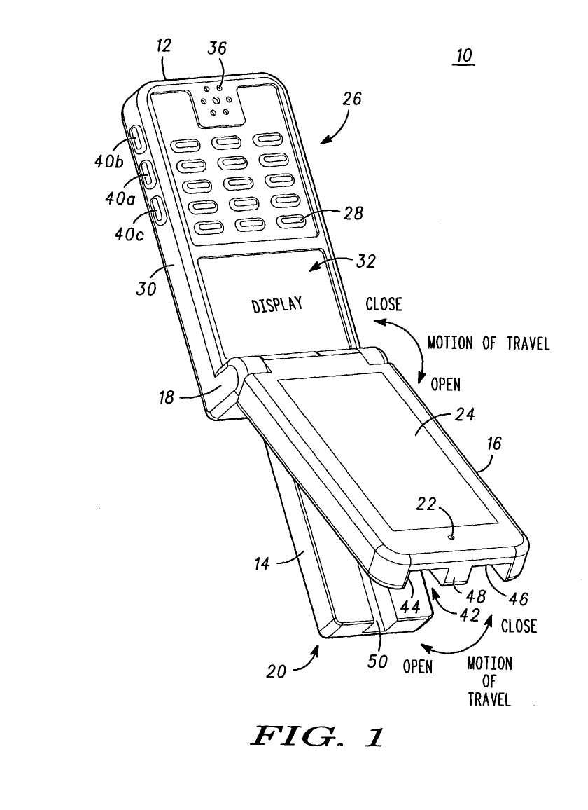

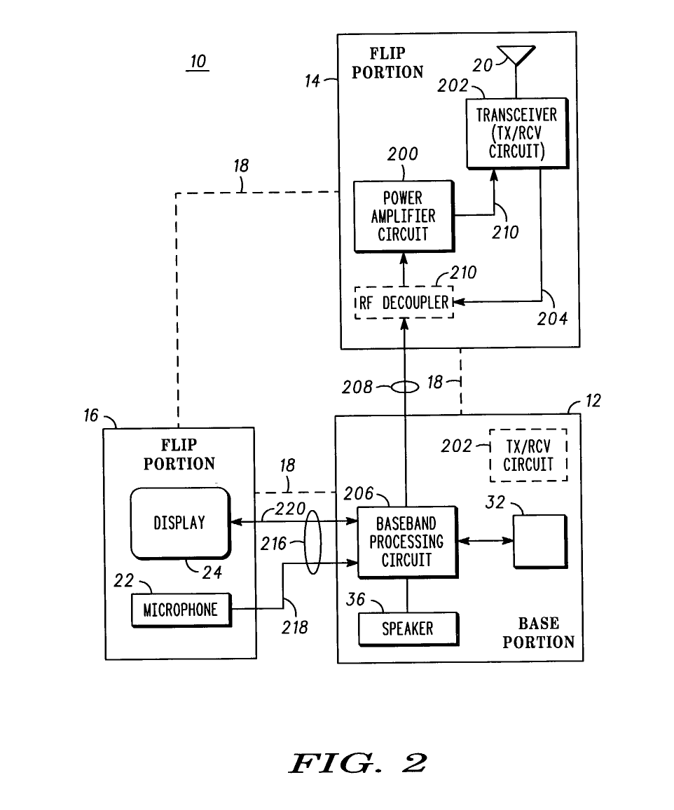

Referring to FIGS. 1 and 2, FIG. 1 illustrates a perspective view of one example of a fully open hand held communication device 10 that includes a base portion 12, a first flip portion 14 and a second flip portion 16. For purposes of illustration only, and not limitation, the hand held communication device 10 is shown to be a hand held wireless telephone. However, it will be understood that the invention is applicable to any suitable hand held wireless device. FIG. 2 is a block diagram illustrating partitioning of elements within the flip sections of the hand held communication device shown in FIG. 1.

The base portion 12, the first flip portion 14, and the second flip portion 16 are pivotal with respect to one another through a hinge 18. Hence, the first flip portion 14 and the second flip portion 16 are pivotal with the base portion 12. The first flip portion includes an antenna 20 located, in this embodiment, at a distal end of the first flip portion 14. The first flip portion 14 also includes a power amplifier circuit 200 (FIG. 2) that is operatively coupled to the antenna 20. As shown, major radiating elements are combined on the antenna flip portion, the first flip portion 14, which is at a fixed distance from a user's head when the hand held communication device 10 is in an open position.

The second flip portion 16 is also pivotal with respect to the base portion 12 through the hinge 18 and is also pivotal with respect to the first flip portion 14 through the hinge 18, and includes a microphone 22 and/or a display 24. It will be recognized that although the hinge 18 provides the mechanical pivoting operation, any suitable structure may be used. Additional components may be included on the second flip portion 16 as desired, but preferably the second flip portion 16 does not include the power amplifier circuit 200 although other transmit and receive circuitry may be employed or other processing circuitry may be housed on the flip portion 16 as desired. If desired, the second flip portion 16 may be made from a conductive plastic or other suitable material or may include a conductive element therein for shielding the antenna 20 from a user of the hand held communication device 10 when the hand held communication device 10 is in operation. The conductive element may be for example any suitable conductive material forming a suitable ground plane or a non-grounded antenna shield.

The antenna 20 may include any suitable radiating element that is preferably located at a distal end of the first flip portion 14 and may include, for example, a fixed antenna, a telescoping antenna or any other suitable antenna structure. The first flip portion 14 may also include a transceiver circuit 202 (FIG. 2) that is operative to produce baseband data 204 from a signal received by the antenna 20. The transceiver circuit 202 is operatively coupled to baseband processing circuit 206 located in the second flip portion 16 through, for example, a suitable connector 208, flexible connector, optical coupler or any other suitable coupling mechanism used to communicate baseband data, such as data in a digital domain, that has been provided by or to transceiver circuit 202 for use by the baseband processing circuit 206. The transceiver circuit 202, as known in the art, also includes demodulation and modulation circuitry for demodulating and/or modulating baseband data that is received/transmitted by the antenna 20. As shown, baseband data provided by the baseband processing circuit 206 indicated as being communicated via connector 208, is passed to the power amplifier circuit 200 and amplified, and is output by the power amplifier circuit 200 as amplified information 210 which is then passed to the transceiver circuit 202 which, in this example, includes a modulation circuit for modulating the baseband data for transmission.

To facilitate decoupling of RF energy radiated from the first flip portion 14, a radio frequency decoupler such as RF choke element 210 is included in the first flip portion 14. The radio frequency choke element 210 is operatively coupled to decouple radio frequency energy communicated by the antenna 20 or other source from baseband digital data 208 as communicated in either direction from the first flip portion 14 to the base portion 12.

The base portion 12 includes an input device 26 such as a key pad, or other control devices such as a built in mouse card for additional buttons 28, 30 and 32. These input mechanisms allow a user to select or control operations of the wireless hand held communication device 10 as known in the art. The base portion 12 also includes a display 32 which provides visual information to the user. The display 32 can also serve as a user input device if a graphical key pad is presented on the display. Also, a battery compartment (not shown) is located in a portion of the base portion 12, as known in the art, to house the battery which can typically be one of the heavier components of the device. The base portion 12 further includes a speaker 36 or any other suitable transducer for providing audio signals from a suitable audio circuit in the wireless hand held communication device 10. Additional input mechanisms are presented on a side surface 38 of the base portion 12 and includes for example, additional buttons 40a-40c, such as power buttons, volume buttons or other buttons which can be readily manipulated by a user when holding the hand held communication device 10 in their hand. The base portion 12 may also include the transceiver circuit 202 if desired or any other suitable processing circuitry.

Placing the battery, the input device 26, display 32 and speaker 36 in the base portion 12 makes the base portion 12 the heaviest and thus the portion the user may feel more comfortable in holding. As such, the user is less likely to want to hold the first flip portion 14 containing the antenna. Locating the primary input device 26 in the base portion also forces a user to hold the base portion 12 during key pad operation, again keeping a user's hand away from the first flip portion 14. It will be recognized that the location of the display 32 and input device 26 may be reversed such that the display is above the input interface 26 and that any other suitable location of the input device may be placed at any suitable position in the base portion 12.

The baseband processing circuit 206 located in the base portion 12 communicates information, via suitable link 216, with the second flip portion 16 and also receives audio information 218 provided by the microphone 22. As such, display data 220 may be sent to, or in the case of the display 24 as an input device, may receive data for processing. Although the hand held communication device 10 is shown to include a plurality of displays 32 and 24, it will be recognized that only one display may be used if desired.

The first flip portion 14 and second flip portion 16 form an antenna for the hand held communication device 10 and this embodiment, the second flip portion 16 includes a recessed portion 42 defined by integral side walls 44 and 46 of the second flip portion 16. The recessed portion 42 is sized to receive at least a portion of or substantially all of the first base portion 14. Accordingly, in this embodiment, the first flip portion 14 has a length shorter than that of the second flip portion 16 and is sized to fit within the recessed portion 42 of the second flip portion 16 when the second flip portion 16 and the first flip portion 14 are in a closed position. When closed, the first flip portion 14 lies flush with an outer surface of the second flip portion 16 to provide a compact design. However, it will be recognized that a non-flush configuration could also be used.

The second flip portion 16, in this example, includes a projecting surface 48 along a length of the second flip portion 16 and has an outer surface configuration that mates with a groove 50 in the first flip portion 14. This serves as an alignment mechanism to suitably align the first flip portion 14 and the recessed portion 42 when the device 10 is being closed. It will be recognized that any other suitable alignment mechanism may also be used if desired. The side walls 44 and 46 also serve to protect the first flip portion 14 when the hand held communication device 10 is closed.

The second flip portion 16 also, if desired, may include a conductive element positioned to form an antenna shield that may be suitably grounded if desired to further improve antenna performance. A non-grounded conductive element may also be used if desired.

The RF decoupler 210 may include, but is not limited to, RF chokes on critical signals such as power and ground lines and/or data control signals, optical links, resistors, an inductive transfer structure that allows the base portion 12 to inductively charge a rechargeable cell used to power circuits on another flip portion such as a display or backlight, or any other suitable RF choke structure.

The base portion 12 or second flip portion 16 may also include suitable I/O interfaces such as connectors to allow communication or connection with external devices and may include a short range wireless circuit to communicate with remote devices.

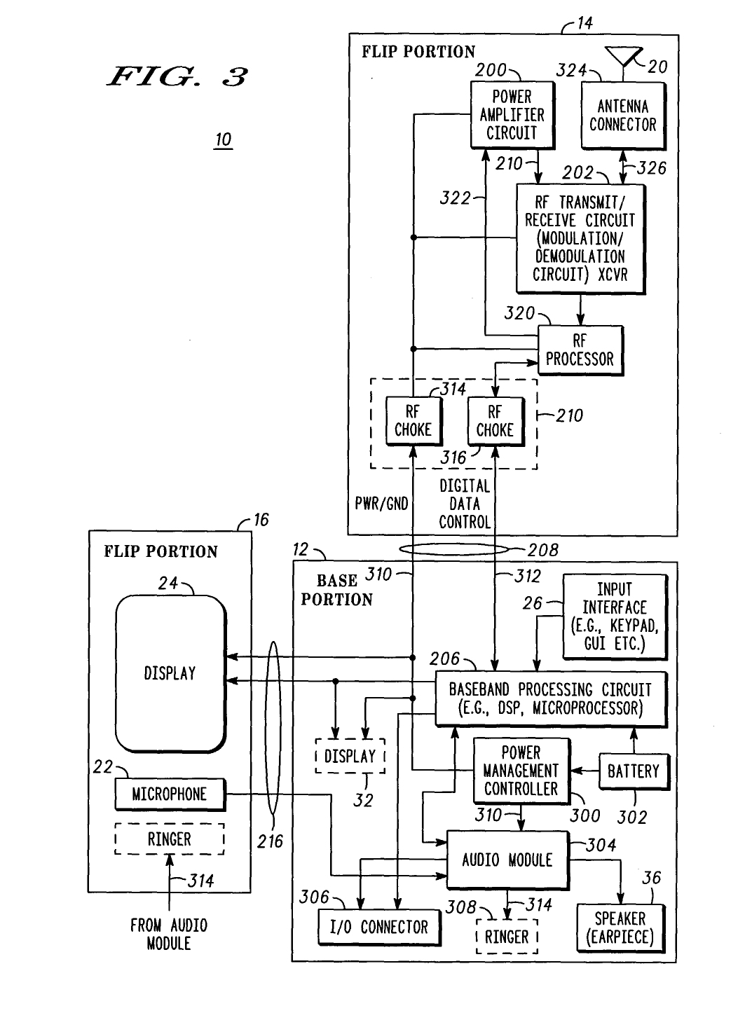

FIG. 3 is a block diagram illustrating in more detail one example of the hand held communication device 10 which shows base portion 12 including a power management controller 300, a battery 302 located in the battery compartment, an audio module 304, an I/O connector 306 and if desired, a ringer 308. Power and ground lines 310 as well as digital data and control lines 312 are coupled via ribbon cables or other coupling mechanisms. The RF decoupler 210 is shown to include RF choke elements 314 and 316, located in the first flip portion 14. The power management controller 300, as known in the art, provides suitable power and ground levels for various components within the hand held communication device 10 and receives a suitable voltage from the battery 302. The audio module 304, as known in the art, provides audio signals generated, for example, by the baseband processing circuit to speaker 36 and if desired, I/O connector 306 so that an external headset or other suitable I/O device can be used. The audio module 304 also, as known in the art, provides a control signal 314 to a ringer if a ringer is used.

The first flip portion 14 is shown also to include an RF processor 320 as known the art that packs and unpacks RF data received from the antenna and sent by the antenna, in a suitable format depending upon the type of system the device is used in. The RF processor 320 receives baseband data and/or control signals 312 and processes the information to produce output baseband data 322 for transmission by the antenna 20, often being amplified by the power amplifier circuit 200. The first flip portion 14 is also shown to include a suitable antenna connector 324 as known in the art, operatively coupled to antenna 20 and communicates information received by the antenna 20 or, communicated by the antenna 20 from the transceiver circuit 202. The decoupling configuration minimizes noise generated by internal circuits as well as placing the antenna 20 and power amplifier circuit 200 on a common flip portion.

In operation, when closed, the first flip portion 14 of the hand held communication device 10 tucks away into the recessed portion 42 in the second flip portion 16 and the base portion 12 folds to protect the display and key pad on the base portion 12 with the second flip portion 16. In one embodiment, having a microphone 22 in the second flip portion 16 allows the second flip portion 16 to more regularly accommodate the first flip portion 14.

The transceiver 202 and power amplifier circuit 200 may be conventional circuits as known in the art. For example, the transceiver circuit 202 and power amplifier circuit 200 may be integrated on a common integrated circuit or may be discrete logic or any suitable combination of hardware, software or firmware. Similarly, the baseband processing circuit 206, power management controller 300, and audio module 304 may also be suitably integrated and may be implemented as any suitable combination of hardware, software or firmware, including but not limited to, a microprocessor, DSP, discrete logic or any other suitable structure. Similarly, the RF processor 320, transceiver 202, and power amplifier circuit 200 may be suitably integrated as desired and may be implemented as any suitable hardware, software or firmware or any suitable combination thereof as known in the art.

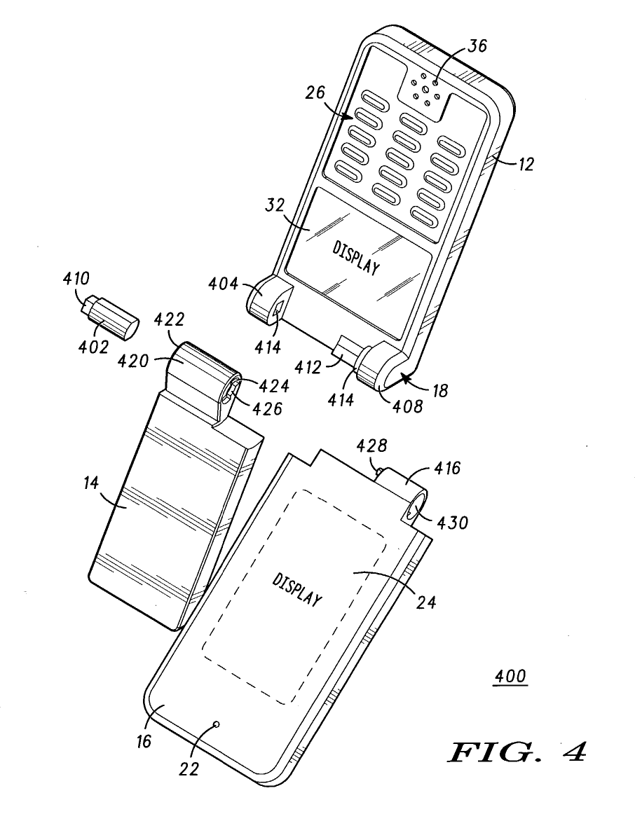

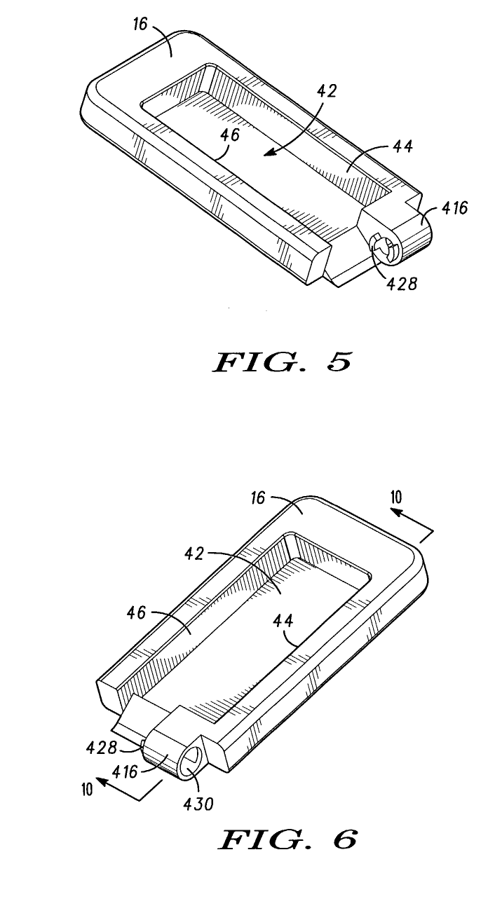

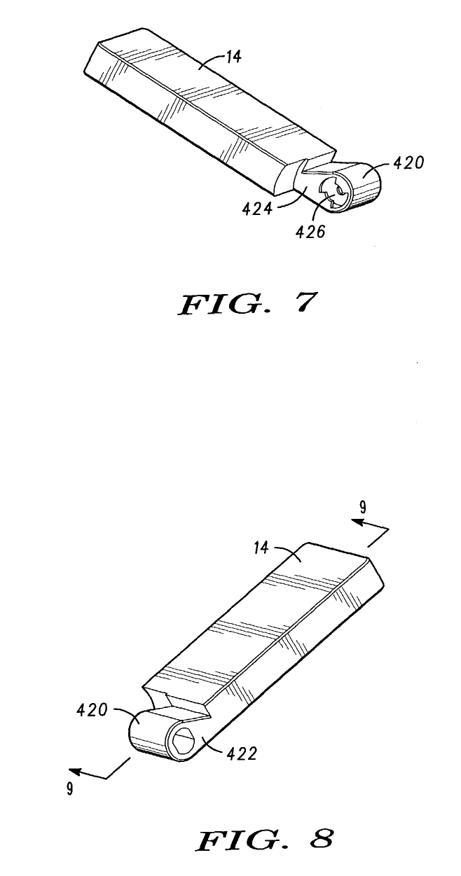

FIGS. 4-10 illustrate another example of a hand held communication device 400 illustrating in more detail the hinge 18 and examples of flip portions 14 and 16. The hinge 18 includes a hinge spring 402, a hinge spring knuckle 404 and knuckle 408. The hinge spring 402 includes a protrusion 410 and as known in the art, houses a spring (not shown). The base portion 12 includes a ramp structure 412 that serves as a separating structure to prevent the second flip portion 16 from pivoting into contact with the first flip portion 14 when the hand held communication device 400 is in a full open position and separates the first and second flip portions 14 and 16 a fixed distance apart when the first and second flip portions 14 and 16 are in a full open position. This makes the antenna 20 more efficient.

The hinge spring knuckle 404 includes an aperture 414 for receiving protrusion 410 of the hinge spring 402. The knuckle 408 includes a protruding ring 414 that rotatingly engages with a hinge hub 416 located on the second flip portion 16.

The first flip portion 14 that houses the antenna and power amplifier, includes a hinge barrel 420 that includes a first end 422 adapted to receive the hinge spring 402, and a second end 424 that contains a rotation limiting surface 426 that engages with a protruding rotation limiting projection 428 located on the hinge hub 416. The hinge hub 416 includes a circular opening 430 opposite the rotation limiting projection 428, that receives the protruding ring 414 of the base portion 12.

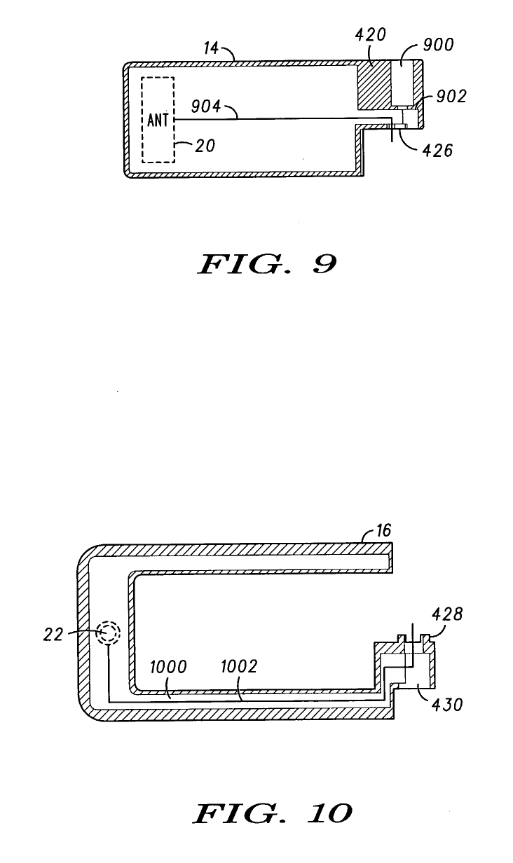

As best seen in FIGS. 9 and 10, the hinge barrel 420 includes a cavity 900 for receiving the hinge spring 402. A wall 902 in the hinge barrel 420 prevents the hinge spring 402 from passing through and contacting the rotation limiting surface 426. Line 904 represents one example of the routing of a flex connector that may be passed inside the first flip portion 14 to connect to the antenna 20.

The second flip portion 16 includes a passage 1000 to allow a flex connector to pass therethrough to connect to the microphone 22 or other suitable circuitry. Line 1002 represents graphically the flex connector passing through the passage 1000.

In operation, when the hand held communication device 400 is in a closed position, a user opens the hand held communication device 400 by pulling the second flip portion 16 overcoming the initial spring bias of the hinge spring 402. When the device is opened, the hinge spring 402 applies a reverse spring bias forcing the first flip portion 14 to deploy in response to movement of the base portion 12 with respect to the second flip portion 16. The ramp structure 412 stops the second flip portion 16 from pivoting on to the first flip portion 14 when the hand held communication device 400 is in an open position. The rotation limiting structure formed by a rotation limiting surface 426 and rotation limiting projection 428 prevents the first flip portion from being more than approximately 30° from the second flip portion 16. As such, the hand held communication device 400 provides a fixed position between the speaker 36 and microphone 22 for a user as well as an automatic deployment of the antenna in the first flip portion 14 when the base portion 12 and flip portion 16 are moved with respect to one another. It will be recognized that although the hinge 18 is configured in the manner described with reference to FIGS. 4-10, any suitable hinge mechanism may be used.

The above disclosed antenna and hand held communication device improves antenna performance, among other advantages, while maintaining suitable functionality for a user. Partitioning the components in the hand held communication device in the various flip portions as described provides improved antenna efficiency and beneficial decoupling to reduce antenna currents, thereby improving device performance. Other advantages will be recognized by those of ordinary skill in the art.

It should be understood that the implementation of other variations and modifications of the invention and its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A wireless, hand held communication device comprising:
a base portion;
a first flip portion pivotal with respect to the base portion, the first flip portion including an antenna and at least a power amplifier circuit operatively coupled to the antenna; and
a second flip portion pivotal with respect to the base portion, the second flip portion including at least one of a display and a microphone.

2. The wireless communication device of claim 1, wherein:
the second flip portion further includes a recessed area;
the first flip portion is pivotal with respect to the second flip portion; and
at least a portion of the first flip portion fits within the recessed area of the second flip portion when the second flip portion and the first flip portion are in a closed position.

3. The wireless communication device of claim 2, wherein the second flip portion is interposed between the base portion and the first flip portion and wherein:
the second flip portion further includes a conductive element positioned to form an antenna shield and a at least one side wall defining the recessed area to receive the at least a portion of the first flip portion; and
the first flip portion further includes a transceiver circuit, operatively coupled to the antenna, for demodulating data received by the antenna and modulating data for transmission by the antenna.

4. The wireless communication device of claim 2, wherein the first flip portion is shorter in length than the second flip portion.

5. The wireless communication device of claim 1, further comprising a separating structure that separates the first and second flip portions a fixed distance apart when the first and second flip portions are in a full open position.

6. The wireless communication device of claim 1, wherein the first flip portion further includes a radio frequency choke element operatively coupled to at least decouple radio frequency energy communicated by the antenna from baseband digital data.

7. A wireless, hand held communication device comprising:
a base portion;
a first flip portion, pivotal with respect to the base portion, including an antenna; and
a second flip portion, also pivotal with respect to the base portion; that includes a recessed area;
wherein at least a portion of the first flip portion fits within the recessed area of the second flip portion when the second flip portion and the first flip portion are in a closed position.

8. The wireless communication device of claim 7, wherein the second flip portion includes a plurality of side walls defining the recessed area that are configured to receive the at least a portion of the first flip portion.

9. A hand held communication device comprising:
a base portion including at least a speaker and a baseband processing circuit operative to at least process baseband data from a signal received by an antenna;
a first flip portion pivotal with respect to the base portion, the first flip portion including the antenna, a power amplifier circuit operatively coupled to the antenna, and a demodulation circuit operatively coupled to the antenna and the baseband processing circuit, the demodulation circuit operative to produce the baseband data from the signal received by the antenna; and
a second flip portion pivotal with respect to the base portion and including at least a microphone.

10. The hand held communication device of claim 9, wherein:
the second flip portion includes a recessed area; and
the first flip portion is pivotal with respect to the second flip portion; and
at least a portion of the first flip portion fits within the recessed area of the second flip portion when the second flip portion and the first flip portion are in a closed position.

11. The hand held communication device of claim 10, wherein the second flip portion is interposed between the base portion and the first flip portion and wherein:
the second flip portion further includes a conductive element positioned to form an antenna shield and a plurality of side walls defining the recessed area; and
the first flip portion further includes a transceiver circuit operatively coupled to the antenna for demodulating the signal received by the antenna and modulating data for transmission by the antenna.

12. The hand held communication device of claim 11 wherein the first flip portion is shorter in length than the second flip portion.

13. The hand held communication device of claim 9, further comprising a separating structure that separates the first and second flip portions a fixed distance apart when the first and second flip portions are in a full open position.

14. The hand held communication device of claim 9, wherein the first flip portion includes a radio frequency choke element operatively coupled to decouple radio frequency energy communicated by the antenna from baseband digital data.

15. The hand held communication device of claim 10, wherein:
the base portion further includes an input device, a display, and a battery compartment; and
the second flip portion further includes a conductive element coupled to form an antenna shield and a plurality of side walls defining the recessed area.
